(19) United States
(12) Patent Application Publication
(10) Pub. No.: US 2004/0154103 A1
(43) Pub. Date: Aug. 12, 2004

(54) Bed, particulary hospital and/or nursing bed

(76) Inventor: Ernst Bock, Verl (DE)

Correspondence Address: CANTOR COLBURN, LLP, 55 GRIFFIN ROAD SOUTH, BLOOMFIELD, CT, 06002

(21) Appl. No.: 10/466,841

(22) PCT Filed: Jan. 21, 2002
(86) PCT No.: PCT/EP02/00564

(30) Foreign Application Priority Data
Jan. 19, 2001 (EP) 011011214.3

(51) Int. Cl. A61G 7/08

(52) U.S. Cl. 5/611; 5/600; 5/81.1 R

(57) ABSTRACT

The invention relates to a bed, particularly a hospital and/or nursing bed, consisting of a bedstead that comprises a bed frame and a supporting structure, wherein the bed frame is formed by longitudinal and transverse beams. In order to create a bed that is easy and economical to produce and is also suited to accommodating heavy persons, it is suggested that the bed frame contain additional weight-baring latticework elements.

The invention relates to a bed, particularly a hospital and/or nursing bed, consisting of a bedstead comprising a bed frame and a supporting structure, wherein the bed frame is made of longitudinal and transverse beams.

Generic beds are known from the state of the art and are used in practice among other things in the hospital and/or nursing fields. They serve the purpose of allowing the patient to assume a comfortable reclined or sitting position in the bed that is appropriate for the respective illness or required care. For this purpose generic beds generally are equipped with lifting devices for raising and lowering the bedstead as well as additional adjusting mechanisms with regard to the resting surface.

One bed of this type is revealed for example in CH-A-167 118. It depicts a hospital and/or care bed, which is formed from a bed frame and a lifting structure that supports the bed frame. For the purpose of raising and lowering the bed frame a corresponding lifting mechanism is provided, which enables the patient to perform a relative displacement of the bed frame with respect to its height. From DE 44 16 689 we know of a bed, especially a hospital bed, which consists of a bed frame and an added unit with the bed frame that is guided in the bed frame such that its height can be adjusted. Additionally, said bed comprises two driving motors, which can be operated independently from one another and which serve to adjust the height of the bed unit. To ensure that when adjusting the height of the bed unit a certain position, in particular a horizontal position, is maintained, it is suggested that the bed contain a horizontal regulating device for the bed unit with a tilt recognition device for detecting the incline of the bed unit in relation to the bed frame.

DE 195 47 206 C1 as well as EP 0 433 737 B1 for example also reveal, respectively, a hospital and/or nursing bed with a bed frame and a supporting structure carrying the bed frame. The bed frame and the supporting structure are coupled with one another by means of a corresponding lifting mechanism, wherein the bed frame is displaceable in its height relative to the supporting structure. So as not to be dependent upon additional staff, the height of the bed frame can be adjusted by means of a remote control, which can be operated by the patient.

Finally DE 22 23 271 reveals a hospital bed with a top element and a chassis, wherein the top element can be lifted and lowered relative to the chassis. In order to improve lifting comfort as well as to avoid the disadvantages that are associated with the use of hydraulic lifting devices, it is suggested here that a mechanical canting plate device for lifting and lowering the top element be provided, and that a hydraulic damper support for controlling the descending operation be provided.

Beds of this type also usually contain supporting rollers, which are formed by foot rollers that are displaceable around both their lateral and their vertical axes and ensure that the bed can be moved with little effort and is easy to maneuver.

Commercially available hospital and/or nursing beds are designed for standard sizes and/or standard dimensions. They generally have a standard resting surface dimension of 90×200 cm. The lifting power that is generally available from the lifting device is designed for a lifting weight of up to about 200 kg. Here however it must be taken into account that the overall lifting weight the lifting mechanism must displace is composed of the weight of the patient in the bed and those parts of the bed itself that can be displaced with regard to height. Thus the maximum permissible patient weight is usually limited to about 130 to 140 kg, which also applies to the beds of the above-described documents.

Particularly with regard to the hoisting capability of the lifting device, standard hospital and/or nursing beds are disadvantageously not suited for overweight patients. For one, there is the risk that the bed design will not withstand use by overweight patients, and secondly a safe operation of the lifting device cannot be guaranteed when lifting power of over 200 kg is required. Moreover, the available resting surface of 90×200 cm is frequently not sufficient for overweight people to enable them to rest comfortably.

In order to provide heavy patients with the opportunity to make use of hospital and/or nursing beds that have corresponding comfort features in terms of use and operation, such as the height adjustment or the resting surface adjustment feature, special designs are required, which must be manufactured individually. However this is very expensive.

Considering the above, it is the object of the invention to make a bed available, which can be manufactured easily and economically and which is suited for accommodating even heavy patients.

To attain this object, the invention suggests that the bed frame comprise additional weight-bearing latticework elements.

This measure provides a bed frame which is reinforced as such and which is suited to accommodate heavier weights. Additionally, the bed frame pursuant to the invention is more resistant to torsion and bending.

With the bed pursuant to the invention, a bed is provided for the first time that can be manufactured economically in series and is suited for accommodating heavy loads, which affords even heavy patients the opportunity of using hospital and/or nursing beds that contain conventional operating and comfort devices, such as lifting and resting surface adjustments. Within the scope of the invention, heavy loads represent body weights of up to 350 kg.

The bed pursuant to the invention comprises a lifting device for raising and lowering the bedstead, which makes it possible to generate a considerably greater lifting power over the state of the art so that even when the permissible overall weight is being utilized the bedstead can be raised and lowered while all safety aspects are taken into consideration. The adjustment device for the resting surface is also adjusted for use by heavy persons.

Pursuant to one feature of the invention, the additional weight-bearing latticework elements, which are arranged on the bed frame, are crossbars formed by rectangular tubes. Said bars are welded to the bed frame and effect a reinforcement of the bed frame, which allows overall a higher weight to be supported. Alternatively, the cross-bars can also be screwed to the bed frame.

Pursuant to another feature of the invention, the bedstead comprises a bed frame structure that is arranged on the bed frame, wherein said structure contains additional reinforcement elements in the form of reinforcement struts. These serve the purpose of additionally reinforcing the bed frame structure, which consists of bed frame supports and transverse wales, similar to a latticework design. The supporting structure also comprises one additional reinforcement wale. Just like the cross-bars of the bed frame, the reinforcement struts of the bed frame structure as well as the reinforcement wale of the supporting structure are welded to the entire configuration, however other types of connections, such as a screw assembly or glued assembly, are also feasible.

On each of its two end faces the bed frame of the bed specified in the invention contains a bed frame structure that is welded to the bed frame. The bed frame structures and the bed frame together form the bedstead. The bedstead is provided with a supporting structure on either end face. Each supporting structure in turn comprises a supporting wale carried by supporting rollers, wherein said wale contains upwardly directed supporting legs. Pursuant to the invention, a reinforcement wale is added to the supporting wale. The upwardly extending supporting legs are designed to correspond to the hollow bed frame supports of the bed frame structure and are inserted therein when the bed specified in the invention is assembled. Each supporting structure contains a separate lifting device, which couples the supporting structure with the appropriate bed frame structure. In this manner it is possible to achieve a relative movement of the bed frame relative to the supporting structures by raising or lowering the bed frame supports by means of the lifting device, guided by the supporting legs of the supporting structure.

All the bed components are designed or dimensioned in such a reinforced fashion that the bed specified in the invention can lift heavy loads of up to 350 kg. Even when adding such a heavy load, both the lifting device used to raise and lower the bedstead and the adjusting device used to level and align the resting surface can be used beneficially to ensure an optimized resting position for the patient on the bed. Trendelenburg positioning should be mentioned here as an example.

Pursuant to another feature of the invention, the height of the bedstead can be adjusted mechanically, electromechanically and/or hydraulically or pneumatically relative to each of the two supporting structures by means of a corresponding lifting mechanism. For this purpose, each lifting device contains a lifting motor. Said motor generates beneficially a lifting power of 5000 N. To supply the lifting motor with electrical energy, an appropriate transformer can be provided.

Furthermore, the lifting device comprises a pneumatically or hydraulically operated lifting piston. Alternatively, the lifting device can also be formed by a toothed rack-and-pinion configuration.

Pursuant to a particular advantage of the invention, the lifting motors of the lifting devices can be operated independently of one another so that the bedstead can be displaced individually relative to each supporting structure via a raising and/or lowering motion. In this manner, it is possible to place the resting surface in a position that is inclined toward the floor.

Pursuant to another feature of the invention, the supporting structure comprises supporting rollers on its base. Said supporting rollers are beneficially designed as foot rollers that can be displaced around both the transverse axis and the vertical axis and have the ability to lift a carrying force of at least 150 kg. For example, each supporting structure can contain two supporting rollers so that the bed specified in the invention contains a total of four supporting rollers, thus ensuring a minimum carrying force of 600 kg.

Pursuant to another feature of the invention, the bed frame of the bed specified in the invention is equipped with a resting surface, which is reinforced with additional crossbars. Said resting surface can be adjusted by means of resting surface motors, which are provided for this purpose. For this, preferably two parallel connected resting surface motors are provided, which the patient in the bed can control individually by means of a corresponding remote control. In this manner the desired inclined position can be precisely adjusted by modifying the resting surface. The resting surface motors preferably generate an adjusting force of 10,000 N each.

Pursuant to a further feature of the invention, a resting surface support is provided, which consists of water-resistant multiplex laminated wood. According to another feature of the invention, the laminated wood can contain a metal inner reinforcement.

In order to secure the patient in the bed, a side rail that surrounds the bed frame can also be provided. The side rail is preferably formed of wood with an integrated inner metal reinforcement. For the hospital version of the bed, the side rail can also be designed as a steel side rail with plastic end sections.

Pursuant to an additional advantageous embodiment, the bed specified in the invention offers a larger resting surface than the standard dimension of 90×200 cm so that even an overweight person who naturally requires more space is afforded the opportunity of resting comfortably. This is called for in particular when side rails are arranged on the bed to prevent the person lying in bed from falling out. Without an expanded resting surface, the overweight patient would literally be constricted. It is therefore suggested that the resting surface be expanded, for example to 120 cm. In order to ensure easy maneuvering of the bed it is further suggested that the additional resting surface be designed on the standard resting surface having a width of 90 cm such that it can be folded away if necessary, returning the bed to the standard width. In this, it is possible e.g. to equip the beds in the invention from the beginning with swiveling side areas, which expand the resting surface for example to 120 cm, wherein the width can again be reduced if necessary to the standard 90 cm by folding down the side areas.

Pursuant to an additional advantageous embodiment, it is suggested that an expansion element of the desired width be arranged on a standard width bed, in keeping with the modular concept. This can be accomplished, for example, via movable elements making it possible to fold away the expansion elements. This is possible, for example, with simple snap-fit elements, hinges, or the like. In this context, standard-width beds can be equipped with configuration devices, onto which the expansion elements can be hooked, hung, or otherwise attached. Due to this feature, beds for heavy people that have a broader resting surface do not have to be stored and made available separately; instead, it is possible to expand the beds if needed to the required width.

Moreover, it is suggested that a support be additionally arranged at least in the connecting area of the main resting surface with the expansion element, offering further support to the side piece preventing any unintended collapse of the side piece under heavier patient weights. Furthermore, the invention suggests individually foldable resting surface, foot, and head elements. This does not influence or impair the movement of the individual elements, as enabled by the lifting devices. Additionally the side pieces should be designed in such a reinforced manner that they can withstand the increased weight requirements posed by heavy patients.

By being able to fold away the resting surfaces, free maneuverability of the bed is ensured. One problem particularly in clinics is that doors generally have standard widths and beds are matched to said doors particularly in order to ensure free transportation of the patient in his bed. The advantageous design of equipping the bed with fold-away expansion side pieces, which can be either attached to the standard resting surface on a substantially permanent basis by means of hinges or the like, or arranged on the bed subsequently as needed in a movable fashion via configuration devices, thus broadening the resting surface, offers the overweight patient a comfortable resting surface of adequate width, wherein the maneuverability of the expanded bed is not limited since the expansion regions can be folded away if necessary in order to allow passage e.g. through doors. The side rails can be arranged on the expansion elements.

Additional advantages and features of the invention result from the following description based on the drawings. They show:

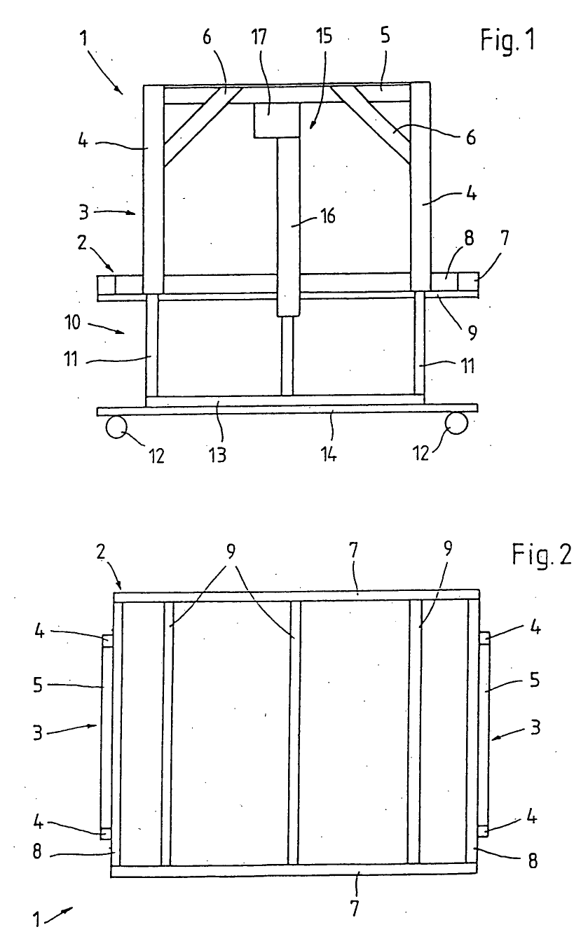

FIG. 1 a diagrammatic end face view of the invented bed;

FIG. 2 a diagrammatic top view of the invented bed, and

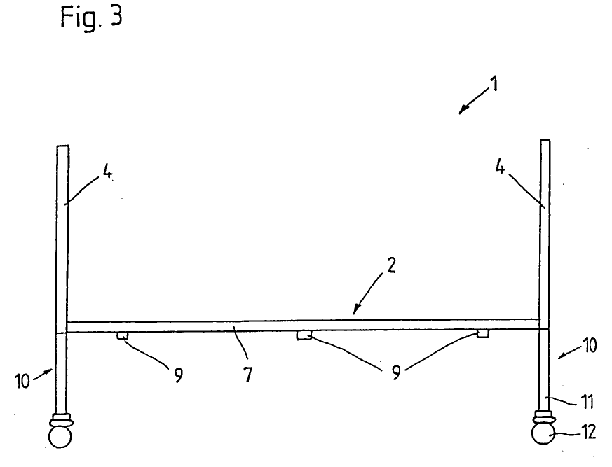

FIG. 3 a diagrammatic side view of the invented bed.

The invented bed consists of a bed frame 2, two bed frame structures 3 arranged respectively on the end faces of the bed frame 2, and two supporting structures 10. The bed frame 2 and the bed frame structures 3 are screwed together or welded together and jointly form the bedstead 1. This connection is revealed most clearly in FIG. 3.

The bed frame 2 in turn consists of two longitudinal beams 7 and two transverse beams 8, which are connected to one another forming a rectangular supporting frame. For the purpose of lifting heavy loads of up to 350 kg, the bed frame 2 is additionally equipped with weight-bearing latticework elements in the form of cross-bars 9. This is shown in FIG. 2.

A bed frame structure 3 in turn comprises two bed frame supports 4 and one transverse wale 5 that connects the two bed frame supports 4 to one another. In FIG. 1 the transverse wale 5 is designed for example as an angular element. To reinforce the bed frame structure 3, two additional reinforcement struts 6 are provided. These connect the transverse wale 5 and the bed frame supports 4 to one another also like latticework.

FIG. 1 furthermore reveals that each of the two supporting structures 10 is formed by one supporting wale 13, which contains two upwardly extending supporting legs 11, which are firmly attached to the supporting wale 13. For reinforcement purposes a reinforcement wale 14 is also provided. The supporting legs 11 are each designed to correspond to the hollow bed frame supports 4 and are inserted therein in the assembled bed. In this, the bed frame supports 4 and the supporting legs 11 are preferably made of hollow rectangular profile tubes, wherein the outer dimensions are adjusted such that the supporting legs 11 can be guided into the bed frame supports 4.

Each supporting structure 10 is coupled with the corresponding bed frame structure 3 by means of an appropriate lifting device 15. By operating the lifting device 15, a relative movement, i.e. a lifting and lowering, of the bedstead 1 toward the supporting structures 10 can be effected. Advantageously the two lifting devices can be operated independently of one another so that it is also possible to adjust the positions of the bed frame 2 that are inclined relative to the floor.

The lifting device 15 in turn consists of a lifting piston 16 and a lifting motor 17. In order to accommodate a heavy load, each of the two lifting motors 17 generates a lifting power of up to 5000 N. As an alternative to a lifting piston 16, it is also possible to provide a toothed rack-and-pinion configuration.

The bed specified in the invention additionally contains a resting surface, which is not shown in the drawings. Said resting surface contains additional cross-bars for reinforcement purposes and can be adjusted in its alignment by means of two parallel connected resting surface motors. Each of the two resting surface motors generates an adjusting force of at least 10,000 N.

Overall, the bed specified in the invention provides a configuration that is designed for heavy loads of up to 350 kg, making it possible for heavy persons to assume comfortable inclined and/or sitting positions, which above all are adequate for the care they are receiving. The dimensioning of the invented bed is such that not only is the carrying function guaranteed when adding up to 350 kg; it is also guaranteed that the lifting and/or resting surface motors will enable the required alignment of the entire bedstead and/or of the resting surface.

### LEGEND

1 Bedstead

2 Bed Frame

3 Bed Frame Structure

4 Bed Frame Support

5 Transverse Wale

6 Reinforcement Strut

7 Longitudinal Beam

8 Transverse Beam

9 Cross-Bar

10 Supporting Structure

11 Supporting Leg

12 Supporting Roller

13 Supporting Wale

14 Reinforcement Wale

15 Lifting Device

16 Lifting Piston

17 Lifting Motor

1. Bed consisting of a bedstead that comprises a bed frame and a supporting structure, wherein the bed frame is formed by longitudinal and transverse beams, characterized in that the bed frame contains additional weight-bearing latticework elements.

2. Bed pursuant to claim 1, characterized in that the latticework elements are cross-bars that are arranged cross-wise to the direction of the longitudinal beams of the bed frame, wherein the longitudinal beams of the bed frame and the additional cross-bars are preferably arranged mutually perpendicular.

3. Bed pursuant to one of the claims 1 or 2, characterized in that the bedstead comprises a bed frame structure that is arranged on the bed frame, wherein said structure comprises reinforcement struts as additional weight-bearing latticework elements.

4. Bed pursuant to one of the claims 1 through 3, characterized in that the cross-bars and/or the reinforcement struts are rectangular tubes.

5. Bed pursuant to one of the claims 1 through 4, characterized in that the cross-bars and/or the reinforcement struts are welded to the bed frame and/or the bed frame structure.

6. Bed pursuant to one of the claims 1 through 5, characterized in that the supporting structure contains at least one reinforcement wale as an additional weight-bearing latticework element, wherein said wale is preferably welded to the supporting structure.

7. Bed pursuant to one of the claims 1 through 8, characterized in that the bedstead can be displaced with regard to its height relative to the supporting structure, for which purpose the bed and supporting structures are coupled to one another by means of a lifting device.

8. Bed pursuant to claim 7, characterized in that the lifting device contains at least one lifting motor, which preferably generates a lifting power of at least 5000 N.

9. Bed pursuant to one of the preceding claims, characterized in that the bedstead is equipped on each of its end faces with a separate supporting structure, wherein each supporting structure is coupled to the bedstead by means of its own lifting device.

10. Bed pursuant to claim 9, characterized in that the lifting motors of the lifting devices can be operated independently of one another.

11. Bed pursuant to one of the preceding claims, characterized in that the supporting structure on the base is equipped with supporting rollers, wherein each supporting roller has a carrying force of at least 150 kg.

12. Bed pursuant to one of the preceding claims, characterized in that the bed frame is equipped with a resting surface that is reinforced with additional cross-bars.

13. Bed pursuant to claim 12, characterized in that the resting surface can be adjusted, wherein for the purpose of adjusting the resting surface two parallel connected resting surface motors are provided, each of which generates an adjusting force of at least 10,000 N.

14. Bed pursuant to one of the preceding claims, characterized in that the resting surface support is made of laminated wood and contains an inner metal reinforcement.

15. Bed pursuant to one or more of the preceding claims, characterized in that at least partial areas of the resting surface can be folded away such that when these areas are folded down the bed has a narrower width than in the folded-out state.

16. Bed pursuant to one ore more of the preceding claims, characterized in that at least partial regions of the resting surfaces as well as head and foot elements can be folded away independently of one another.

17. Bed pursuant to one or more of the preceding claims, characterized in that expansion elements can be temporarily arranged on the resting surfaces, head, and foot elements so that the resting surface can be expanded.
